(19) United States
(12) Patent Application Publication
(10) Pub. No.: US 2022/0162884 A1
(43) Pub. Date: May 26, 2022

(54) ELECTRIC LOCK

(71) Applicant: Eltronix Co. Ltd, Hsinchu City (TW)

(72) Inventors: Jen-Tsang Chen, Hsinchu County (TW); Cheng-Yi Hsu, Hsinchu County (TW)

(73) Assignee: Eltronix Co. Ltd, Hsinchu City (TW)

(21) Appl. No.: 17/483,826

(22) Filed: Sep. 24, 2021

(30) Foreign Application Priority Data
Nov. 24, 2020 (TW) 109141202

(51) Int. Cl. E05B 47/00; E05B 17/00

(52) U.S. Cl. CPC E05B 47/0012; E05B 2047/0017; E05B 2047/0094; E05B 17/0037

(57) ABSTRACT

An electric lock including a main base, a lock bolt, an elastic rod, a driving assembly, and a remote receiver is provided. The lock bolt is pivotally rotatably disposed on a top surface of the main base. The elastic rod is movably arranged in the main base and connected to a free end of the lock bolt. The driving assembly is disposed on a side of the main base and connected to the elastic rod. The remote receiver is coupled to the driving assembly. In a remote mode, the remote receiver is adapted to receive a signal to turn on the driving assembly, and the driving assembly drives the lock bolt through the elastic rod to rotate relative to the main base to switch to a locked state or an unlocked state.

### CROSS-REFERENCE TO RELATED APPLICATION

This application claims the priority benefit of Taiwan application serial no. 109141202, filed on Nov. 24, 2020. The entirety of the above-mentioned patent application is hereby incorporated by reference herein and made a part of this specification.

### BACKGROUND OF THE INVENTION

### Field of the Invention

The invention relates to an electric lock, and particularly relates to an electric lock applied to a vehicle compartment.

### Description of Related Art

Nowadays, a scooter is commonly provided with a compartment in the body thereof for storage, and a seat is rotatably connected to the body to cover the compartment. For the purpose of anti-theft, a lock is installed inside the compartment and engaged with a fastener provided on the seat, so as to lock the seat. Since the conventional locks are mostly operated manually, a key is required to unlock the lock of the body and remove the locked state between the seat and the body, such an unlocking process is not only complicated but also causes inconvenience in use.

Therefore, an electric lock has been proposed. Such an electric lock can be unlocked through remote control. However, the conventional electric lock is difficult to repair when the remote control apparatus is damaged.

### SUMMARY OF THE INVENTION

Embodiments of the invention provide an electric lock capable of being unlocked remotely and manually, and may be unlocked in either way based on needs. Accordingly, the electric lock according to the embodiments of the invention is easy to use.

An embodiment of the invention provides an electric lock including a main base, a lock bolt, an elastic rod, a driving assembly, and a remote receiver. The lock bolt is pivotally rotatably disposed on a top surface of the main base. The elastic rod is movably arranged in the main base and connected to a free end of the lock bolt. The driving assembly is disposed on a side of the main base and connected to the elastic rod. The remote receiver is coupled to the driving assembly. In a remote mode, the remote receiver is adapted to receive a signal to turn on the driving assembly, and the driving assembly drives the lock bolt through the elastic rod to rotate relative to the main base to switch to a locked state or an unlocked state.

According to an embodiment of the invention, the driving assembly includes a motor, a rotary plate, and a linking rod. The rotary plate is disposed on a rotary shaft of the motor, the linking rod is pivotally connected to an eccentric part of the rotary plate and abuts against the elastic rod, the rotary shaft of the motor is adapted to drive the rotary plate to rotate along an axial direction, and the linking rod eccentrically rotates with the rotary plate to move relatively close to or away from the main base.

According to an embodiment of the invention, when the linking rod is relatively close to the main base, the elastic rod is pressed and drives the lock bolt to pivotally rotate in a first rotation direction to switch to the locked state, and when the linking rod is relatively away from the main base, the elastic rod is elastically restored and drives the lock bolt to pivotally rotate in a second rotation direction opposite to the first rotation direction to switch to the unlocked state.

According to an embodiment of the invention, the linking rod includes an eccentric block, a pivot part, and a gripping part. The eccentric block is disposed on an outer periphery of the rotary plate, the pivot part is pivotally connected to the eccentric block, the gripping part is screwed to an end of the pivot part away from the eccentric block and has a recess, and a portion of the elastic rod is located in the recess.

According to an embodiment of the invention, the main base has a sleeve, the elastic rod penetrates through the sleeve and is adapted to linearly slide along the sleeve.

According to an embodiment of the invention, in a manual mode, the elastic rod slides along the sleeve toward a first direction or a second direction opposite to the first direction to drive the lock bolt to rotate relative to the main base and switch to the locked state or the unlocked state.

According to an embodiment of the invention, a free end of the lock bolt has a ring, a first column is pivotally arranged in the ring, an end of the elastic rod is connected to the first column, and when the elastic rod drives the first column, the free end of the lock bolt is adapted to rotate relative to the first column.

According to an embodiment of the invention, the lock bolt has a through hole, the main base has a second column, the through hole of the lock bolt is sleeved on the second column and adapted to rotate about the second column relative to the main base, so that a locking end of the lock bolt protrudes outside the main base or overlaps with the top surface of the main base.

According to an embodiment of the invention, the electric lock further includes a connection frame and a plurality of bolts. The connection frame is disposed on the main base, the bolts penetrate through a first end of the connection frame and the main base to integrate the connection frame and the main base, and a second end of the connection frame accommodates the driving assembly.

According to an embodiment of the invention, the electric lock further includes a receptacle disposed on the connection frame and coupled to the driving assembly. The receptacle is coupled to an external source and supplies power to the driving assembly.

Based on the above, in the electric lock according to the embodiments of the invention, a remote controller transmits a wireless signal to the remote receiver to turn on the driving assembly. In addition, the driving assembly drives the lock bolt through the elastic rod to rotate relative to the main base, so as to switch to the locked state or the unlocked state. Accordingly, compared with a conventional lock that is locked or unlocked manually, the electric lock according to the embodiments of the invention is simple and convenient to operate.

Besides, the electric lock according to the embodiments of the invention can still be locked and unlocked manually. In the case where the remote controller is damaged, the electric lock can still be locked or unlocked manually, which further facilitate the convenience of the electric lock.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic perspective view illustrating an electric lock according to an embodiment of the invention.

FIG. 1B is a schematic exploded view of components of the electric lock of FIG. 1A.

FIG. 2A is a schematic view illustrating an unlocked state of the electric lock of FIG. 1A.

FIG. 2B is a view illustrating a locked state of the electric lock shown in FIG. 2A in a remote mode.

FIG. 2C is a view illustrating a locked state of the electric lock shown in FIG. 2A in a manual mode.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

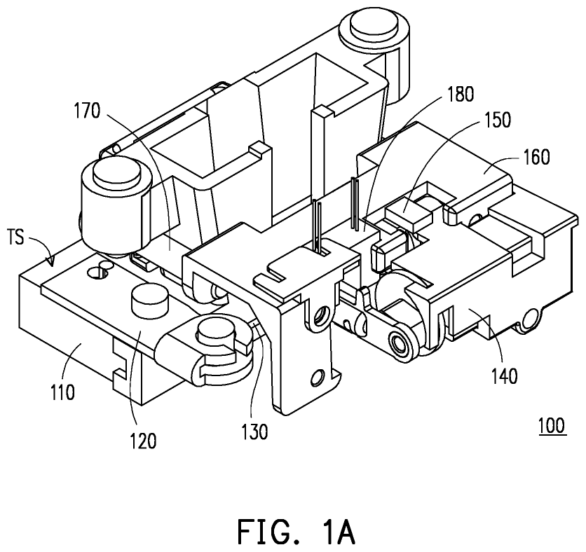

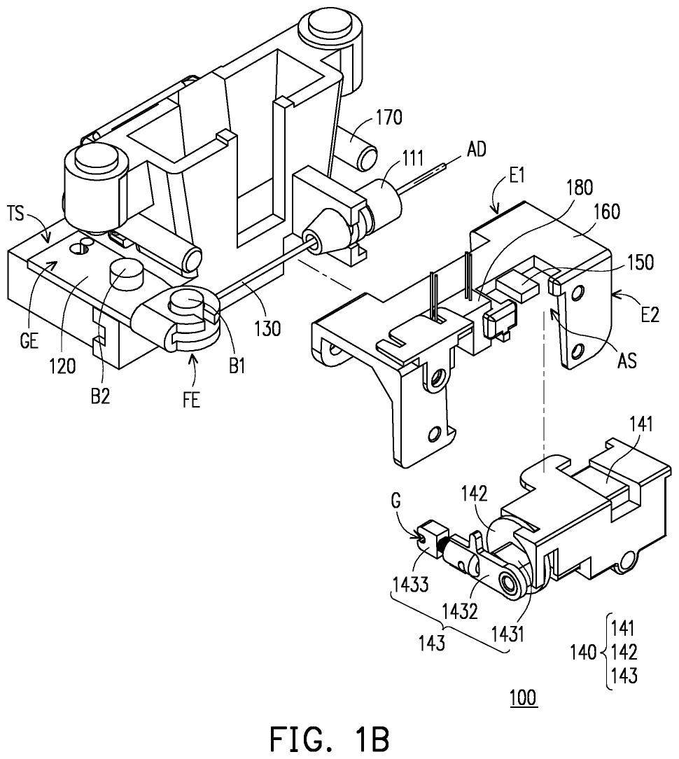

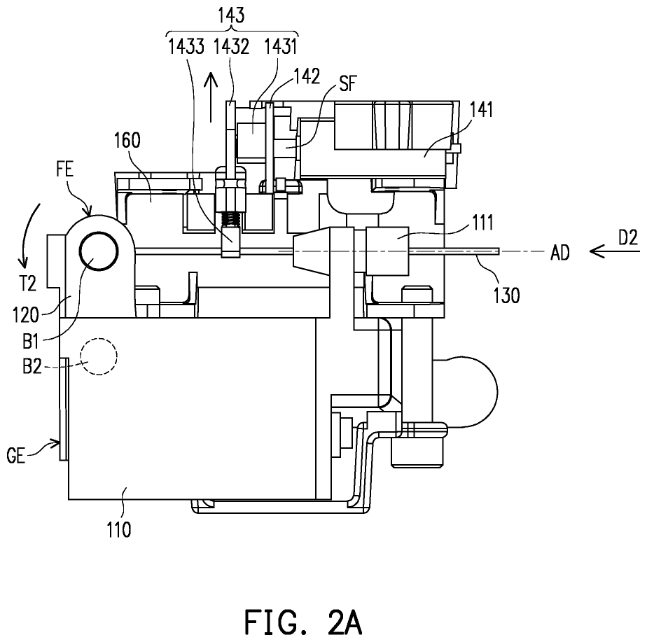

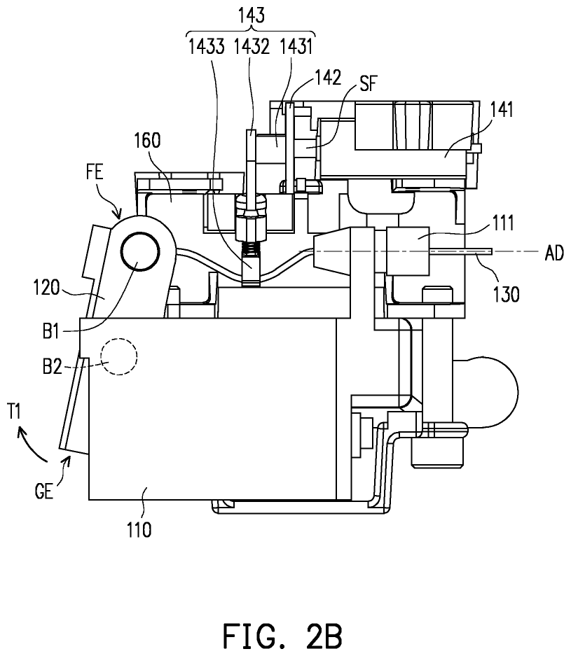

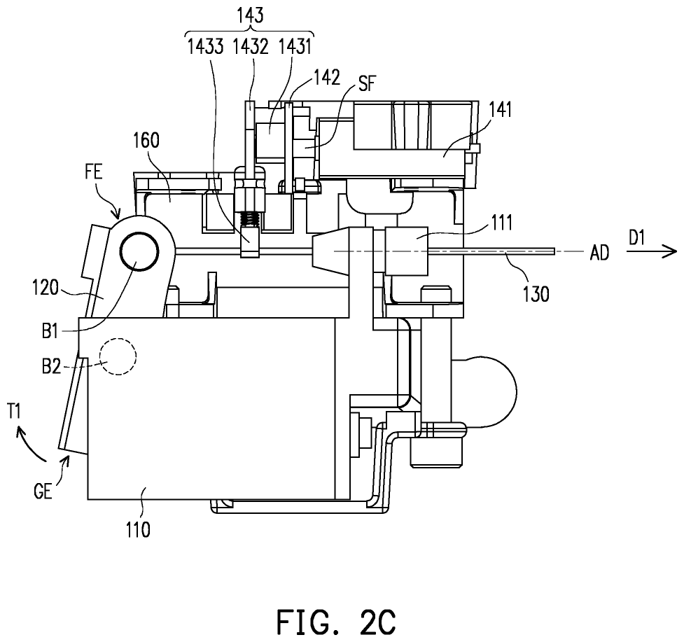

FIG. 1A is a schematic perspective view illustrating an electric lock according to an embodiment of the invention. FIG. 1B is a schematic exploded view of components of the electric lock of FIG. 1A. FIG. 2A is a schematic view illustrating an unlocked state of the electric lock of FIG. 1A. FIG. 2B is a view illustrating a locked state of the electric lock shown in FIG. 2A in a remote mode. FIG. 2C is a view illustrating a locked state of the electric lock shown in FIG. 2A in a manual mode.

Referring to FIGS. 1A and 1B, an electric lock 100 according to the embodiment is suitable for a compartment of a vehicle, such as a scooter, a motorcycle, powered by electricity or gasoline. The electric lock 100 includes a main base 110, a lock bolt 120, an elastic rod 130, a driving assembly 140, and a remote receiver 150.

The main base 110 is suitable to be fixed onto an inner wall surface of the compartment (not shown). The lock bolt 120 is pivotally rotatably disposed on a top surface TS of the main base 110 and is configured to lock a fastener on a seat (not shown).

The elastic rod 130 is movably arranged in a sleeve 111 of the main base 110 and connected to a free end FE of the lock bolt 120. Specifically, the sleeve 111 is disposed on a side of the main base 110 opposite to the lock bolt 120 and suspended above the top surface TS, and the elastic rod 130 penetrates through the sleeve 111 and is adapted to slide linearly along the sleeve 111 to drive the lock bolt 120.

The driving assembly 140 is disposed on a side of the main base 110 and is connected to the elastic rod 130. In addition, the driving assembly 140 is powered by an external power source to operate automatically. The remove receiver 150 is coupled to the driving assembly 140 and is adapted to receive a wireless signal (through a wireless transmission technology, such as infrared rays, Bluetooth, RFID, or the like). In a remote mode, the remote receiver 150 is adapted to receive a signal of a remote controller (not shown) to start the driving assembly 140, and the driving assembly 140 drives the lock bolt 120 through the elastic rod 130 to rotate relative to the main base 110, so as to switch to a locked state or an unlocked state.

Referring to FIGS. 1A and 1B a connection frame 160, a plurality of bolts 170, and a receptacle 180 are provided. The connection frame 160 is disposed on the main base 110, and the bolts 170 penetrate through a first end E1 of the connection frame 160 and the main base 110 to integrate the connection frame 160 and the main base 110. A second end E2 of the connection frame 160 forms an accommodating space AS to accommodate and be engaged with the driving assembly 140. The receptacle 180 is disposed on the connection frame 160 and coupled to the driving assembly 140, and is adapted to be coupled to the external power source to supply power to the driving assembly 140.

Referring to FIGS. 1A, 1B, and 2A, the driving assembly 140 includes a motor 141, a rotary plate 142, and a linking rod 143. The rotary plate 142 is disposed on a rotary shaft SF of the motor 141. The linking rod 143 is pivotally connected to an eccentric part of the rotary plate 142 and abuts against a portion of the elastic rod 130. The rotary shaft SF of the motor 141 is adapted to drive the rotary plate 142 to rotate along an axial direction AD, such as rotating in a clockwise direction or a counter-clockwise direction. Since the linking rod 143 is pivotally connected to the eccentric part of the rotary plate 142, the linking rod 143 may rotate eccentrically with the rotary plate 142 to move relatively close to the main base 110 and press the elastic rod 130 or move relatively away from the main base 110 and release the elastic rod 130.

Specifically, the linking rod 143 includes an eccentric block 1431, a pivot part 1432, and a gripping part 1433. The eccentric block 1431 is disposed on an outer periphery of the rotary plate 142. The pivot part 1432 is pivotally connected to the eccentric block 1431. The gripping part 1433 is screwed to an end of the pivot part 1432 away from the eccentric block 1431 and the gripping part 1433 has a recess G. A portion of the elastic rod 130 is located in the recess G.

In addition, the gripping part 1433 has a screw structure, and the pivot part 1432 has a screw hole. By combining the screwing structure and the screw hole, the length dimension of the gripping part 1433 and the pivot part 1432 is manually adjustable to meet the elastic strength of the elastic rod 130.

In the remote mode, the remote receiver 150 turns on the driving assembly 140. The rotary shaft SF of the motor 141 drives the rotary plate 142 to pivotally rotate in the clockwise or counter-clockwise direction.

During the rotation, as shown in FIG. 2A and then FIG. 2B, when the linking rod 143 is relatively close to the main base 110, the gripping part 1433 presses the elastic rod 130 to deform the elastic rod 130 and drive the lock bolt 120 to pivotally rotate relative to the main base 110 toward a first rotation direction T1, so as to switch to a locked state (i.e., a locking end GE of the lock bolt 120 protrudes outside the main base 110).

Referring to FIG. 2B and then FIG. 2A, when the linking rod 143 is relatively away from the main base 110, the gripping part 1433 stops pressing the elastic rod 130, and the elastic rod 130 is elastically restored and drives the lock bolt 120 to pivotally rotate relative to the main base 110 toward a second rotation direction T2 opposite to the first rotation direction T1, so as to switch to an unlocked state (i.e., the locking end GE of the lock bolt 120 overlaps with the top of the main base 110).

Referring to FIGS. 2A and 2C, in the manual mode, the remote receiver 150 and the driving assembly 140 are not activated. The user may pull the elastic rod 130 to slide linearly along the axial direction AD of the sleeve 111 toward a first direction D1 by an external force, so as to drive the lock bolt 120 to rotate relative to the main base 110 toward the first rotation direction T1 and switch to the locked state (i.e., the locking end GE of the lock bolt 120 protrudes out of the main base 110).

The user may also push the elastic rod 130 to slide along the axial direction AD of the sleeve 111 toward a second direction D2 opposite to the first direction D1 by an external force, so as to drive the lock bolt 120 to rotate toward the second rotation direction T2 relative to the main base 110 to switch to the unlocked state (i.e., the locking end GE of the lock bolt 120 overlaps with the top of the main base 110).

The elastic rod 130 is adapted to slide along the axial direction AD in the recess G of the gripping part 1433 without being interfered.

Referring to FIGS. 1A and 1B, the free end FE of the lock bolt 120 has a ring 121, and a first column B1 is pivotally arranged in the ring 121. The first end E1 of the elastic rod 130 is connected to the first column B1. When the elastic rod 130 drives the first column B1 along the axial direction AD, the free end FE of the lock bolt 120 is adapted to rotate relative to the first column B1 and be driven by the first column B1 to swing laterally relative to the main base 110 (as shown in FIGS. 2A and 2C).

The lock bolt 120 is provided with a through hole TH formed at the center of the lock bolt 120. The main base 110 has a second column B2 formed on the top surface TS. The through hole TH of the lock bolt 120 is sleeved on the second column B2 and is adapted to rotate about the second column B2 relative to the main base 110. Accordingly, the locking end GE of the lock bolt 120 protrudes out of the main base 110 or overlaps with the top surface TS of the main base 110.

In view of the foregoing, in the electric lock according to the embodiments of the invention, the remote controller transmits a wireless signal to the remote receiver to turn on the driving assembly. In addition, the driving assembly drives the lock bolt through the elastic rod to rotate relative to the main base, so as to switch to the locked state or the unlocked state. Accordingly, compared with a conventional lock that is locked or unlocked manually, the electric lock according to the embodiments of the invention is simple and convenient to operate.

Besides, the electric lock according to the embodiments of the invention can still be locked and unlocked manually. In the case where the remote controller is damaged, the electric lock can still be locked or unlocked manually, which further facilitate the convenience of the electric lock.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An electric lock, comprising:
a main base;
a lock bolt is pivotally rotatably disposed on a top surface of the main base;
an elastic rod, movably arranged in the main base and connected to a free end of the lock bolt;
a driving assembly, disposed on a side of the main base and connected to the elastic rod; and
a remote receiver, coupled to the driving assembly,
wherein in a remote mode, the remote receiver is adapted to receive a signal to turn on the driving assembly, and the driving assembly drives the lock bolt through the elastic rod to rotate relative to the main base, so as to switch to a locked state or an unlocked state.

2. The electric lock as claimed in claim 1, wherein the driving assembly comprises a motor, a rotary plate, and a linking rod, the rotary plate is disposed on a rotary shaft of the motor, the linking rod is pivotally connected to an eccentric part of the rotary plate and abuts against the elastic rod, the rotary shaft of the motor is adapted to drive the rotary plate to rotate along an axial direction, the linking rod eccentrically rotates with the rotary plate to move relatively close to or away from the main base.

3. The electric lock as claimed in claim 2, wherein when the linking rod is relatively close to the main base, the elastic rod is pressed and drives the lock bolt to pivotally rotate in a first rotation direction to switch to the locked state, and when the linking rod is relatively away from the main base, the elastic rod is elastically restored and drives the lock bolt to pivotally rotate in a second rotation direction opposite to the first rotation direction to switch to the unlocked state.

4. The electric lock as claimed in claim 2, wherein the linking rod comprises an eccentric block, a pivot part, and a gripping part, the eccentric block is disposed on an outer periphery of the rotary plate, the pivot part is pivotally connected to the eccentric block, the gripping part is screwed to an end of the pivot part away from the eccentric block and has a recess, and a portion of the elastic rod is located in the recess.

5. The electric lock as claimed in claim 1, wherein the main base has a sleeve, the elastic rod penetrates through the sleeve and is adapted to linearly slide along the sleeve.

6. The electric lock as claimed in claim 5, wherein in a manual mode, the elastic rod slides along the sleeve toward a first direction or a second direction opposite to the first direction to drive the lock bolt to rotate relative to the main base and switch to the locked state or the unlocked state.

7. The electric lock as claimed in claim 1, wherein a free end of the lock bolt has a ring, a first column is pivotally arranged in the ring, an end of the elastic rod is connected to the first column, and when the elastic rod drives the first column, the free end of the lock bolt is adapted to rotate relative to the first column.

8. The electric lock as claimed in claim 1, wherein the lock bolt has a through hole, the main base has a second column, the through hole of the lock bolt is sleeved on the second column and adapted to rotate about the second column relative to the main base, so that a locking end of the lock bolt protrudes outside the main base or overlaps with the top surface of the main base.

9. The electric lock as claimed in claim 1, further comprising a connection frame and a plurality of bolts, the connection frame is disposed on the main base, the bolts penetrate through a first end of the connection frame and the main base to integrate the connection frame and the main base, and a second end of the connection frame accommodates the driving assembly.

10. The electric lock as claimed in claim 9, further comprising a receptacle, disposed on the connection frame and coupled to the driving assembly, wherein the receptacle is coupled to an external source and supplies power to the driving assembly.
